(19) United States
(12) Patent Application Publication
(10) Pub. No.: US 2012/0267874 A1
(43) Pub. Date: Oct. 25, 2012

(54) WHEELCHAIR HAVING A HEIGHT-ADJUSTABLE AND INCLINATION-ADJUSTABLE SEAT

(75) Inventors: Gunter Schrickel, Koenigsee (DE); Johannes Koenig, Gotha (DE)

(73) Assignee: OTTO BOCK MOBILITY SOLUTIONS GMBH, Koenigsee (DE)

(21) Appl. No.: 13/501,419

(22) PCT Filed: Oct. 12, 2010
(86) PCT No.: PCT/DE10/01200

§ 371 Date: May 23, 2012

(30) Foreign Application Priority Data
Oct. 13, 2009 (DE) 102009049536.3

(51) Int. Cl. A61G 5/10; B60N 2/16; B60N 2/10

(52) U.S. Cl. 280/304.1

(57) ABSTRACT

The invention relates to a wheelchair, comprising a frame (10), drive wheels (11) arranged on the frame (10), at least one steerable steering wheel (12), and a seat (14), the height (H) and inclination (N) of which can be set, the height being adjustable by means of a link parallelogram gram (I, II), which is formed by a first link (1) rigidly connected to the frame (10), a second link (2) and a third link (3) connected to the first link (1) in an articulated manner, and a fourth link (4) connected to the second link (2) and the third link (3) in an articulated manner and which is connected to an actuator (6), the wheelchair being characterized in that the link parallelogram (I, II) comprises exactly four links, the seat (14) is pivotably arranged on the hinge point (C) formed by the third link (3) and the fourth link (4), and a second actuator (7) is provided, which is connected to the seat (14) and to one of the links (1, 2, 3, 4).

The invention relates to a wheelchair with a frame, drive wheels arranged on the frame, at least one steerable steering wheel, and a seat which is adjustable in height and inclination, the height being adjustable by means of a link parallelogram, which is formed from a first link, rigidly connected to the frame, two second and third links, connected to the first link in an articulated manner, and a fourth link, connected to the second and third link in an articulated manner, and which is connected to an actuator.

Such a wheelchair is known from DE 10 2008 024 745 A1, for example. This wheelchair is a stand-up wheelchair whose seat can be pivoted to a vertical position in order to bring the user to a standing position, for example so that he can play golf. In this wheelchair, the seat is secured on the parallelogram. To adjust the seat inclination (tilting), the front part of the wheelchair has a telescopic design, such that the parallelogram can he raised or lowered at its front end.

EP 1 413 278 A1 discloses a wheelchair in which the seat is adjustable only in height by means of a link parallelogram, so as to adapt the height of the seat to other objects, for example toilet fittings, chairs or tables.

DE 10 2005 020 914 83 discloses an electric wheelchair which comprises a main frame and a base frame, which are connected to each other by a lifting column. The seat is secured on the base frame and can be adjusted in height via the lifting column. To tilt the seat, an intermediate frame is mounted on the base frame and in turn supports a seat frame. Thus, three frame elements that are individually movable and adjustable relative to one another are mounted on the upper area of the lifting column. Although this allows the position of the seat to be individually adjusted, with the base frame, the intermediate frame and the seat frame being able to form a scissor mechanism, the minimum seat depth is limited by the height of the retracted. lifting column, which needs to have a stable construction so as to be able to safely bear the weight of the person using the wheelchair. However, the scissor mechanism means that the structure between seat and lifting column is again quite high, such that, in order to be able to obtain a reasonable tilting range, the height adjustment range has to be correspondingly small, or vice versa. The design outlay of this wheelchair is also quite high, such that its manufacture is not only difficult but also costly.

Proceeding from this problem, the wheelchair described at the outset is to be improved such that the height and inclination of the seat can be adjusted more easily and the design outlay is reduced, and such that the greatest possible vertical adjustability is obtained along with the highest possible tilting.

To solve this problem, a wheelchair of the type in question is characterized in that the link parallelogram is composed of exactly four links, in that the seat is arranged pivotably on the hinge point formed by the third and fourth link, and in that a second actuator is provided, which is connected at one end to the seat and at the other end to one of the links.

By means of this design, the mechanism needed for the height adjustment of the seat can also be used at the same time to tilt the seat. The range of the possible height adjustment of the seat is thus independent of the possible range of tilting. This wheelchair is therefore particularly suitable for use as a child's wheelchair, since its height can be adapted as the child grows and can therefore he used by the same person over a period of many years.

The link parallelogram is also used exclusively for the height adjustment, but no mechanism adversely affecting the vertical seat height is needed in order to obtain the tilting. In addition to the reduced overall height, a further advantage is that fewer component parts are needed, with the result that assembly time is reduced.

Preferably, the first and/or second actuators are pure linear actuators, which have at least one linearly displaceable rod. The first and/or second actuators can also be designed as telescopic cylinders.

Particularly preferably, the first and/or second actuators can be driven by electric motor. To reduce installation space, the fourth link connecting at one end to the second and third links secured rigidly on the frame has an angled design, wherein the angle is particularly preferably substantially a right angle.

A simple possibility of adjustment of the link parallelogram is achieved if the first actuator is secured at one end on the frame and at the other end on the second link. The adjustment of the inclination of the seat (tilting) can be easily performed if the second actuator is connected to the fourth link.

Two identically designed link parallelograms are preferably provided, arranged parallel to each other. Particularly preferably, however, only a single first and only a single second actuator is provided.

An illustrative embodiment of the invention is described in more detail below with reference to a drawing, in which:

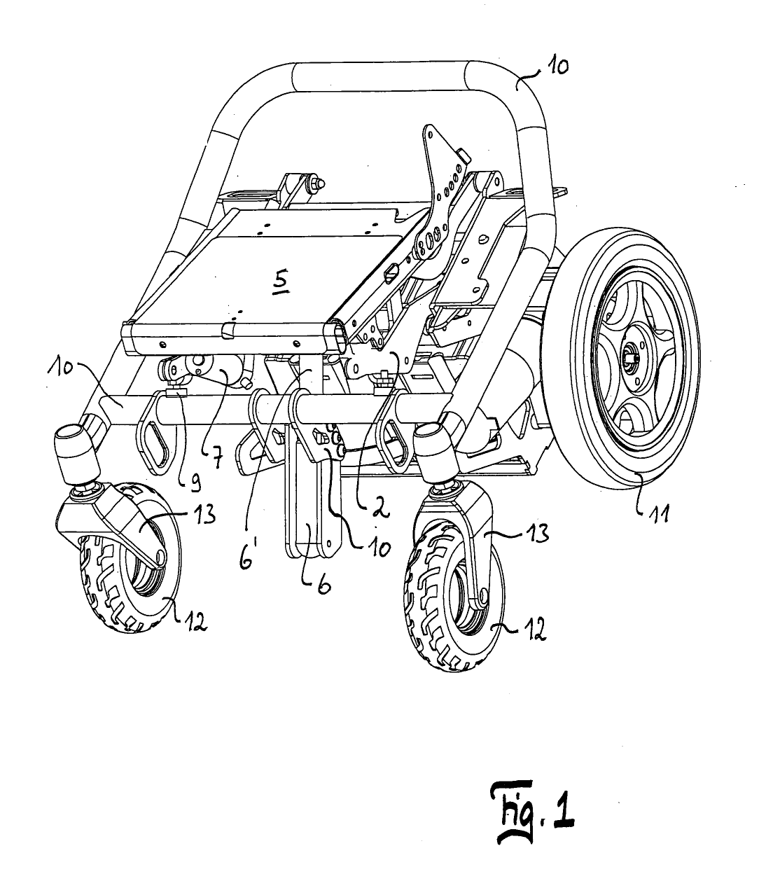

FIG. 1 shows a simplified, perspective view of the wheelchair without the seat;

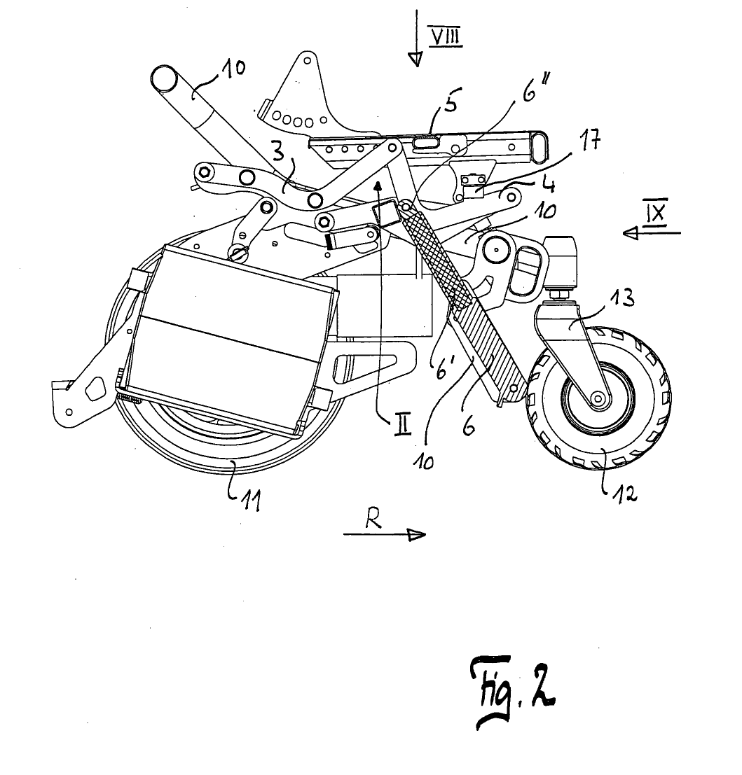

FIG. 2 shows a side view of the wheelchair with the first actuator in cross section;

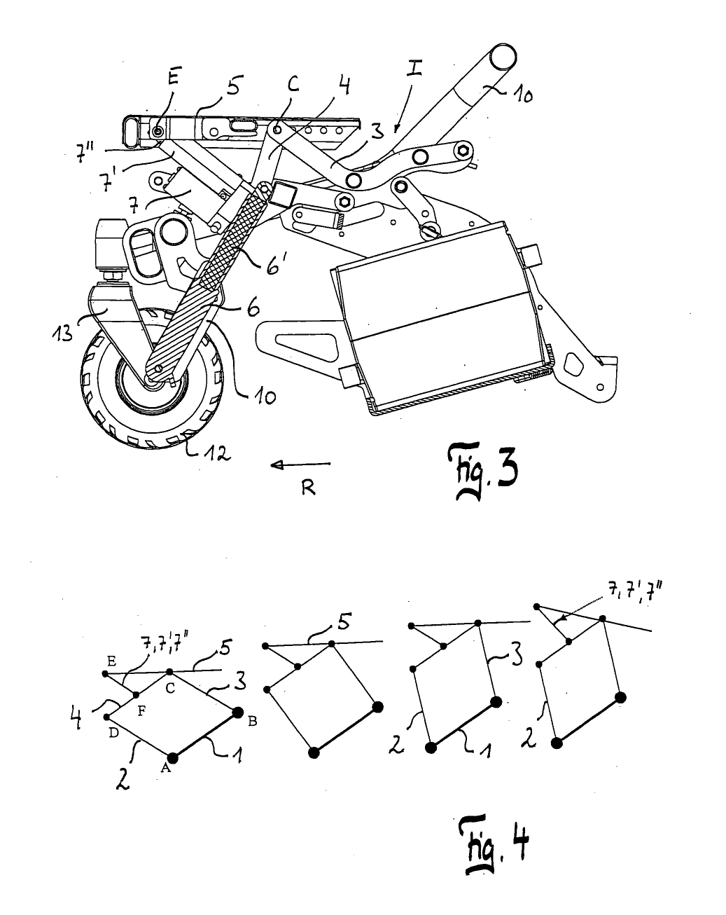

FIG. 3 shows another side view of the wheelchair with the actuator in cross section;

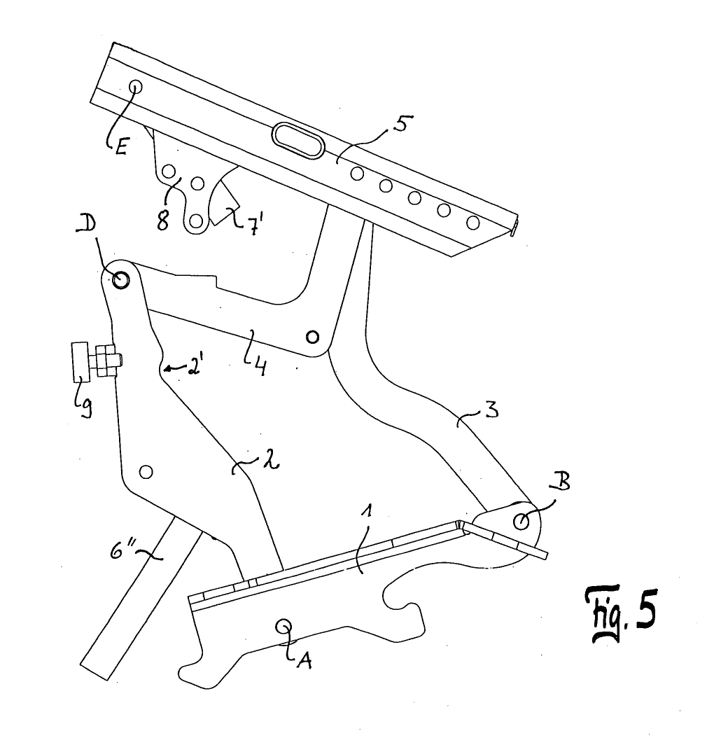

FIG. 4 shows a schematic view of the link parallelogram in different positions;

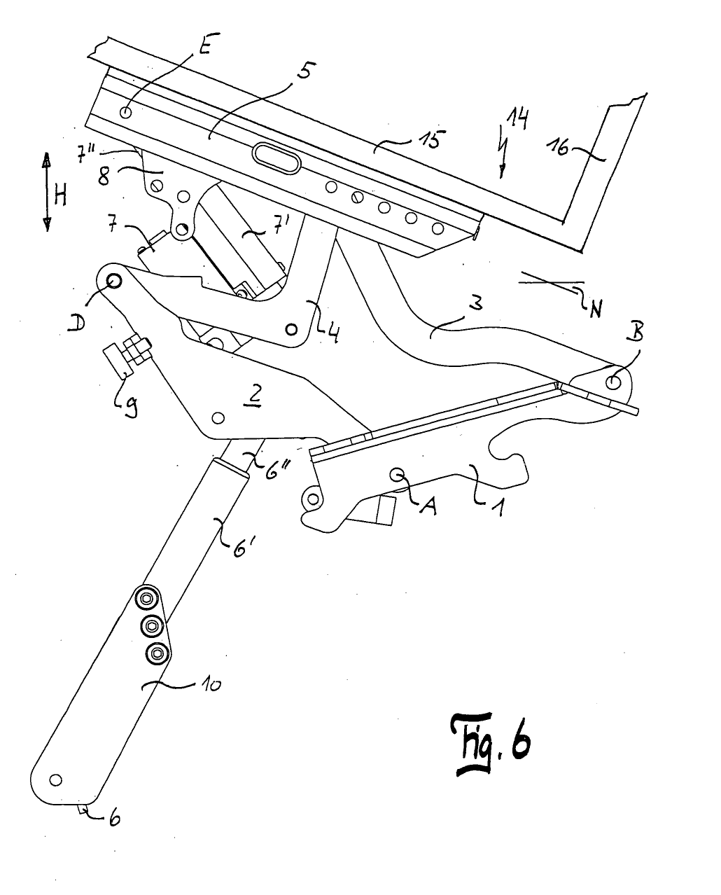

FIG. 5 shows a first view of the link parallelogram of the wheelchair;

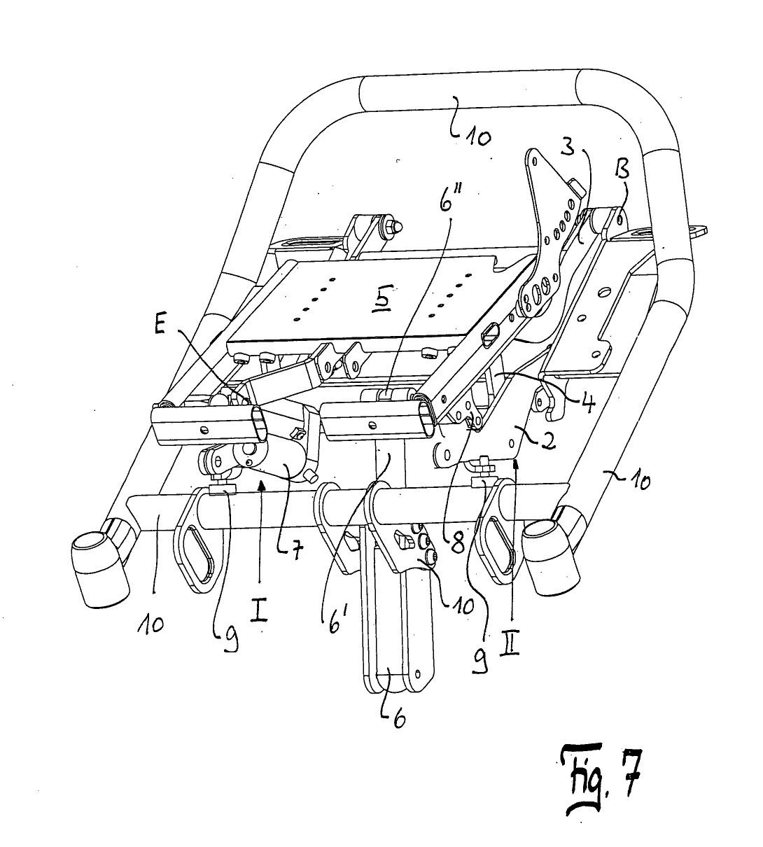

FIG. 6 shows a second view of the link parallelogram of the wheelchair;

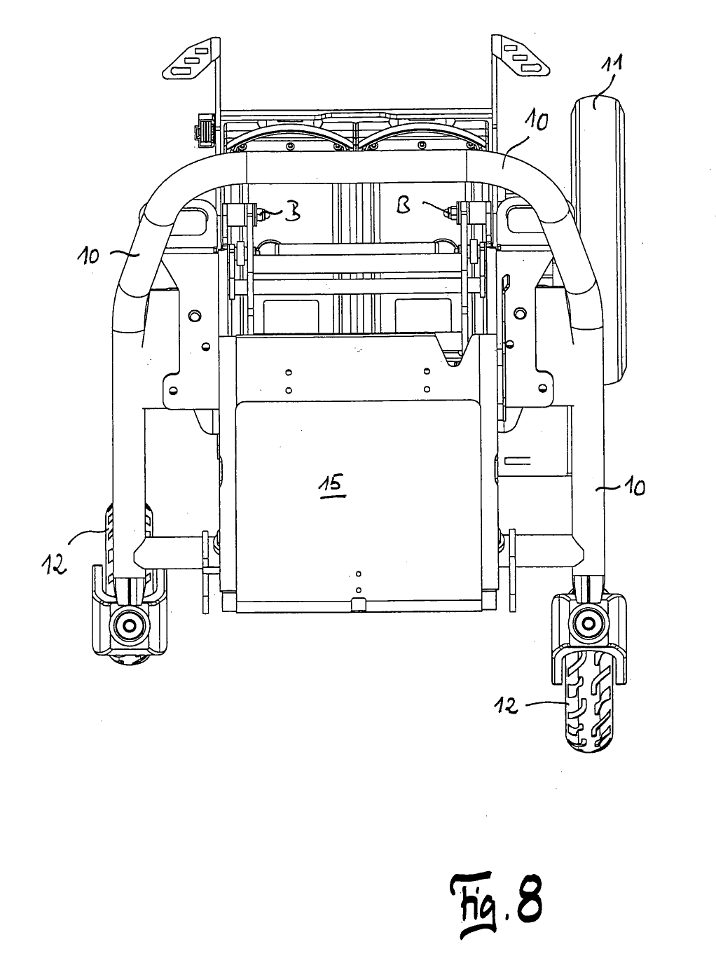

FIG. 7 shows the wheelchair in a view corresponding to FIG. 1, in a more simplified depiction;

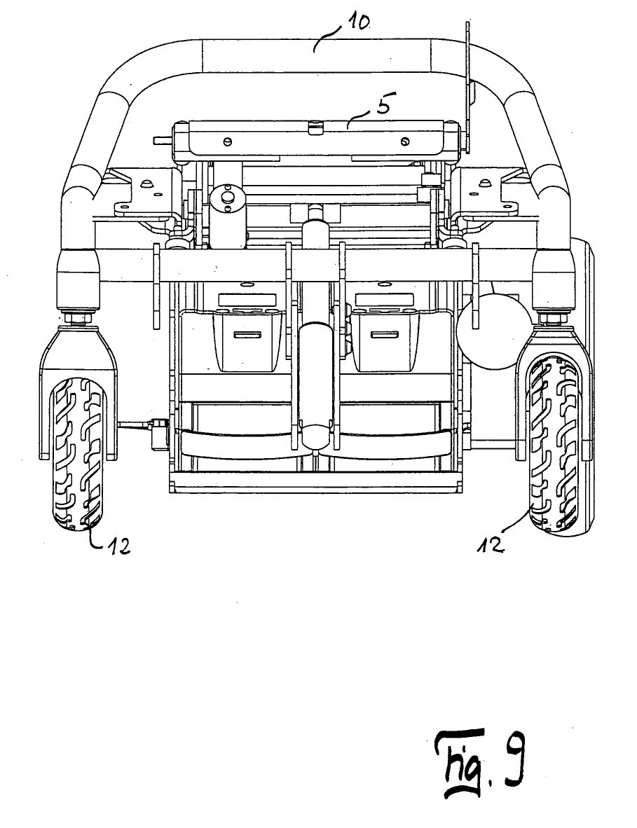

FIG. 8 shows a plan view of the wheelchair in the direction of the viewing arrow VIII according to FIG. 2;

FIG. 9 shows a view of the wheelchair in the direction of the viewing arrow IX according to FIG. 2.

The chassis of the wheelchair is composed principally of the frame 10, on which there are articulated the driven rear wheels 11, and the two steering wheels 12 arranged pivotably via the forks 13 and located at the front as seen in the direction of travel R. Arranged in parallel next to each other are two link parallelograms I, II, which are formed by a first link 1, which is rigidly connected to the frame 10, and by the second link 2, which is connected at the hinge point. A to the link 1 and at the hinge point D to a fourth link 4, and by the third link 3, which is connected at the hinge point B to the link 1 and at the hinge point C to the fourth link 4. A seat plate 5, which carries the seat 14 (cf. FIG. 6) formed from the seat cushion 15 and the padded backrest 16, is connected pivotably at the hinge point C to the third and the fourth link 4. In the front area with respect to the direction of travel R, the telescopic rod 7″ of the linear actuator 7 is secured in an articulated manner to the seat plate 5. The actuator 7 is in turn secured on the fourth link 4. The second actuator 6 with its telescopic rod 6″ is secured at one end on the second link 2 and is articulated at its other end on the frame 10.

The kinematics of the link parallelograms are explained with reference to FIG. 4, taking the example of the link parallelogram I. The seat plate 5 for receiving the seat 14 is placed on the upper pivot point C. Between the left-hand pivot point D and the seat plate 5, a space is formed whose angles and distances remain constant during the lifting movement (from left to right in the drawing). It is thus possible to connect the point F on the link 4 fixedly to the seat plate at articulation point E. As the drawings make clear, the seat plate 5 remains parallel to the ground during the lifting movement, which is initiated by an angle displacement of the link 2. If the connection of the points E and F is made longitudinally displaceable, the tilting is integrated into the lifting mechanism. The actuator 7 is provided for this purpose with its telescopic cylinder 7′ and the telescopic rod 7″. As FIG. 7 shows, only a single actuator 7 is provided. The link parallelogram 11 is simply entrained, in the tilting movement. To shift the link parallelograms I, II, the actuator 6 with its telescopic rod 6″ is provided, which actuator 6 is arranged fixedly at one end on the frame 10 and at the other end on the second link 2. When the telescopic rod 6″ of the actuator 6 is extended, the angle position of the second link 2 is changed (cf. FIGS. 5 and 6), as a result of which the height of the seat plate 5 or of the seat 14 changes. FIG. 5 shows the seat plate 5 in an upper position, while FIG. 6 shows it in a lower position.

In the horizontal position of the seat 14 or of the seat plate 5, the full weight of the user bears thereon. Since only a single actuator 7 is provided for the tilting, the front of the seat plate 5 is only secured on one side to a link parallelogram I. In order to obtain good support of the seat plate 5 on both link parallelograms I, II in this position, a bracket 8, spaced apart in parallel, is provided on the underside of the seat plate 5 and can bear on the link 2. For this purpose, a recess 2′ is provided in the link 2. A buffer 17 is also mounted on the bracket 8, which buffer 17 bears on the link 2 in order to ensure a secure bearing. The buffer 17 consists of a rubber or plastic element, such that clattering noises are avoided. The tilt motor loaded at one side is additionally supported in the load position “sitting”.

Since in the sitting position the entire weight bears only on the one lifting actuator 6, the “lifting unit” (links 1, 2, 3, 4) is supported on the frame 10 via two buffers 9 secured on the links 2. Instead of providing electric actuators, it is also possible, for example, to use blockable gas pressure springs. This then opens up possibilities of use in wheelchairs having no electrical voltage supply.

### LIST OF REFERENCE SIGNS

1 first link
2 second link
3 third link
4 fourth link
5 seat plate
6 actuator
6′ telescopic cylinder
6″ telescopic rod
7 actuator
7′ telescopic cylinder
7″ telescopic rod
8 plate
9 buffer
10 frame
11 drive wheel
12 steering wheel
13 fork
14 seat
15 seat cushion
16 back cushion
17 buffer
A hinge point
B hinge point
C hinge point
D hinge point
E hinge point
F hinge point
R direction of travel

1. A wheelchair with a frame (10), drive wheels (11) arranged on the frame (10), at least one steerable steering wheel (12), and a seat (14) which is adjustable in height (H) and inclination (N), the height being adjustable by means of a link parallelogram (I, II), which is formed by a first link (1), rigidly connected to the frame (10), two second (2) and third (3) links, connected to the first link (1) in an articulated manner, and a fourth link (4), connected to the second (2) and third (3) link in an articulated manner, and which is connected to an actuator (6), characterized in that the link parallelogram (I, II) is composed of exactly four links, in that the seat (14) is arranged pivotably on the hinge point (C) formed by the third (3) and fourth (4) link, and in that a second actuator (7) is provided, which is connected at one end to the seat (14) and at the other end to one of the links (1, 2, 3, 4).

2. The wheelchair as claimed in claim 1, characterized in that the first and/or second actuator (6, 7) has at least one linearly displaceable rod (6″, 7″).

3. The wheelchair as claimed in claim 2, characterized in that the first and/or second actuator (6, 7) has a telescopic cylinder (6′, 7′).

4. The wheelchair as claimed in claim 2 or 3, characterized in. that the first and/or second actuator (6, 7) can be driven by electric motor.

5. The wheelchair as claimed in claim 1, characterized in that the fourth link (4) connecting the first link (1), secured rigidly at one end on the frame (10), the second link (2) and third link (3) has an angled design.

6. The wheelchair as claimed in claim 5, characterized in that the angled fourth link (4) has a substantially right-angled shape.

7. The wheelchair as claimed in one of the preceding claims, characterized in that the first actuator (6) is secured at one end on the frame (10) and at the other end on the second link (2).

8. The wheelchair as claimed in one of the preceding claims, characterized in that the second actuator (7) is connected to the fourth link (4).

9. The wheelchair as claimed in one of the preceding claims, characterized in that two identically designed link parallelograms I, II are provided.

10. The wheelchair as claimed in claim 9, characterized in that only one first (6) and only one second (7) actuator is provided.
